(19) United States
(12) Patent Application Publication
(10) Pub. No.: US 2011/0175999 A1
(43) Pub. Date: Jul. 21, 2011

(54) VIDEO SYSTEM AND METHOD FOR OPERATING SAME

(76) Inventor: Kenneth McCormack, Albany, OR (US)

(21) Appl. No.: 12/688,586

(22) Filed: Jan. 15, 2010

(51) Int. Cl. H04N 7/18

(52) U.S. Cl. 348/143; 348/E07.085

(57) ABSTRACT

A method for operating a video system includes performing a visual surveillance tour of a predetermined control area with a pan/tilt/zoom (PTZ) camera. The method also includes recording at least one video image frame of the predetermined control area. The method further includes recording at least one coordinate value associated with a predetermined coordinate system. The method also includes transmitting each of the at least one video image frame and the at least one coordinate value to at least one storage device. The method further includes indexing the at least one video image frame as a function of the at least one coordinate value. The method also includes retrieving the at least one video image frame based on the at least one coordinate value and displaying the at least one video image frame on at least one video display device.

### BACKGROUND OF THE INVENTION

1. Field of the Invention

The embodiments described herein relate generally to video management and, more particularly, to a method and system for surveillance video review.

2. Description of Related Art

At least some known security systems include visual surveillance systems that are used to monitor physical activities within a predetermined area. At least some of these known visual surveillance systems include pan/tilt/zoom (PTZ) cameras that pan about a vertical axis, tilt about a horizontal axis, and zoom in on selected objects and regions. These known visual surveillance systems are typically generating recorded video streams at a user selected frame rate, wherein such recorded streams are typically lengthy and are stored in a time-continuous manner in a video archive. Many known automated archival retrieval systems search on user-selected thresholds and/or parameters and display video content as an irregular frame rate while skipping areas that may appear to contain uninteresting or low information content. Manual reviews of archived footage may be time-consuming, especially when searching for a change in circumstances and/or events in a particular field of view or in a particular spatial portion of an area under surveillance with a dynamic PTZ camera.

### BRIEF SUMMARY OF THE INVENTION

In one aspect, a method for operating a video system in provided. The method includes performing a visual surveillance tour of a predetermined control area with a pan/tilt/zoom (PTZ) camera. The method also includes recording at least one video image frame of the predetermined control area. The method further includes recording at least one coordinate value associated with a predetermined coordinate system. The method also includes transmitting each of the at least one video image frame and the at least one coordinate value to at least one storage device. The method further includes indexing the at least one video image frame as a function of the at least one coordinate value. The method also includes retrieving the at least one video image frame based on the at least one coordinate value and displaying the at least one video image frame on at least one video display device.

In another aspect, a video system is provided. The video system includes at least one video retrieval device. The system also includes at least one processor coupled with the at least one video retrieval device. The at least one processor is programmed to index at least one video image frame as a function of at least one coordinate value associated with a predetermined coordinate system.

The embodiments described herein provide a surveillance camera system having operational functionality that facilitates discrimination of changes in circumstances in predetermined areas of coverage. As such, the embodiments described herein enable such automated discrimination and further enable subsequent automated selective investigations of such circumstances.

### BRIEF DESCRIPTION OF THE DRAWINGS

FIGS. 1-4 show exemplary embodiments of the visual surveillance system and methods described herein.

FIG. 1 is a schematic view of an exemplary visual surveillance system.

FIG. 2 is a schematic diagram of an exemplary pan/tilt/zoom (PTZ) camera assembly that may be used with the visual surveillance system shown in FIG. 1.

FIG. 3 is a schematic view of an exemplary video retrieval system that may be used with the visual surveillance system shown in FIG. 1.

FIG. 4 is a flow chart of a method for operating the visual surveillance system, the PTZ camera assembly, and the video retrieval system shown in FIGS. 1-3, respectively.

### DETAILED DESCRIPTION OF THE INVENTION

The embodiments described herein provide a video system and a method for operating such video system. More specifically, rather than reviewing extensive video archives in a temporally-aligned manner, the video system described herein excludes video of no or little interest in the video review activities thereby significantly reducing a period of time used for such review. The video system described herein includes a video retrieval system that indexes each recorded video image frame to a distinct set of coordinates. The retrieval method as described herein facilitates access to pan/tilt/zoom (PTZ) camera-based video data by indexing each video image frame to a specific set of telemetry coordinates that include pan angle, tilt angle, and zoom setting, that collectively define a field of view (FOV). Indexing the video image frames with the telemetry coordinates facilitates review of recorded video wherein only video associated with a particular area of interest in a control area is examined. Excluding video of no or little interest in the video review activities significantly reduces a period of time used for such review.

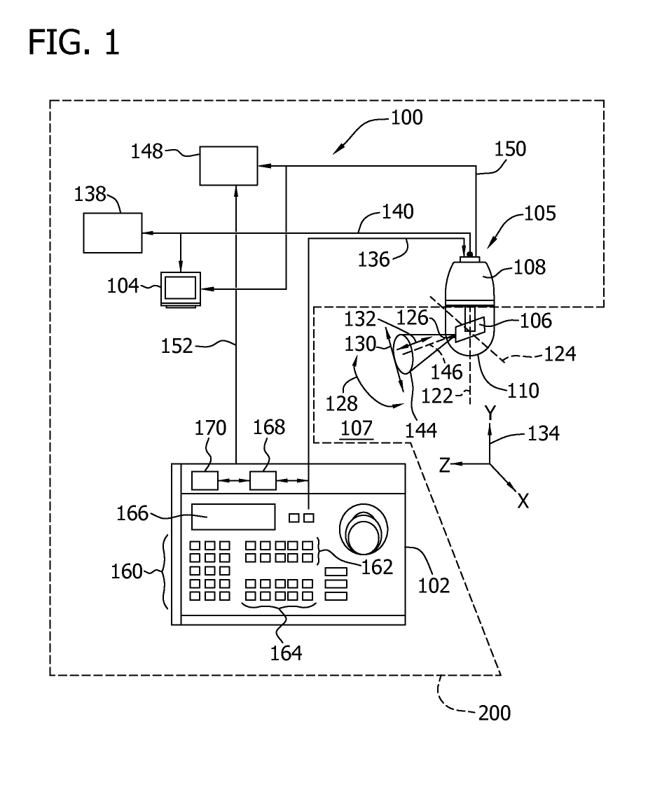

FIG. 1 is a schematic view of an exemplary visual surveillance system 100. Visual surveillance system 100 includes a control panel 102, a display monitor 104, and a visual surveillance camera assembly 105. In the exemplary embodiment, visual surveillance system 100 is a single-camera application configured to visually surveil a predetermined control area 107. Such control areas 107 may include, but not be limited to, access-controlled rooms that are typically unoccupied. Alternatively, visual surveillance system 100 includes any number of camera assemblies 105 to provide coverage of larger or more complex control areas 107 that may include, but not be limited to, large perimeters.

In the exemplary embodiment, visual surveillance camera assembly 105 includes a visual surveillance camera 106 housed in an enclosure 108 having a dome 110 for protecting camera 106 from the environment where camera 106 is located. In the exemplary embodiment, dome 110 is tinted to allow camera 106 to acquire video images of the environment outside of enclosure 108 and prevent individuals in the environment being observed by camera 106 from determining an orientation of camera 106. Alternatively, dome 110 is not tinted.

Also, in the exemplary embodiment, camera 106 is an articulated pan/tilt/zoom (PTZ) camera that is configured to pan about a vertical pan axis 122, tilt about a horizontal tilt axis 124, and control a lens assembly 126 to control a zoom feature of camera 106. For example, PTZ video camera assembly 105 includes a pan mechanism (not shown in FIG. 1) that includes a pan motor and encoder (not shown) and a tilt mechanism (not shown in FIG. 1) that includes a tilt motor and encoder (not shown). The encoders determine an angular position of the pan and tilt motor and generate position signals that are used with a zoom setting to determine an area in the field of view. Panning movement of camera 106 is represented by pan direction arrow 128, tilting movement of camera 106 is represented by tilt arrow 130 and the changing of the focal length of lens assembly 126 of camera 106, i.e., zooming, is represented by zoom arrow 132. As shown with reference to a coordinate system 134, panning motion tracks movement along an x-axis, titling motion tracks movement along a y-axis and focal length adjustment is used to track movement along a z-axis. Signals representing commands to control such capabilities are transmitted from control panel 102 through a control data channel 136. Alternatively, control panel 102 and camera assembly 105 communicate via radio-frequency (RF).

Further, in the exemplary embodiment, video image data signals are transmitted from camera 106 to display monitor 104 and at least one video storage device 138 through a video data channel 140. Alternatively, camera 106 and display monitor 104 and/or video storage device 138 communicate via radio-frequency (RF). More specifically, lens assembly 126 views a portion of control area 107, which is typically remote from control panel 102, and that is in a field of view (FOV) 144 along a viewing axis 146 of lens assembly 126. FOV 144 is defined as the area within a field of view of camera 106 at a predetermined position including a pan angle, tilt angle, and zoom setting. More specifically, axis 146 defines FOV 144 as a function of a horizontal angle (not shown) about vertical pan axis 122, and a vertical angle (not shown) with respect to horizontal tilt axis 124, wherein each angle is at least partially representative of a size value of an associated video frame in the respective dimension. Video images of control area 107 are converted by camera 106 into a plurality of signals that are transmitted to display monitor 104 and/or storage device 138. A video image is acquired of FOV 144 by camera 106 and a video image signal is generated and transmitted to video storage device 138. Video storage device 138 includes any amount of storage capacity that enables operation of system 100 as described herein. Video stored therein is typically referred to as video archives.

Moreover, in the exemplary embodiment, telemetry data signals substantially representative of the pan angle, tilt angle, and FOV 144 are generated by camera 106 and transmitted to display monitor 104 and at least one telemetry storage device 148 through a telemetry data channel 150. Furthermore, telemetry storage device 148 is coupled with control panel 102 via a control channel 152 that is configured to transmit signals substantially representative of control commands. Alternatively, camera 106, control panel 102, display monitor 104, and/or telemetry storage device 148 communicate via radio-frequency (RF). Each frame of video stored within video storage device 138 has a corresponding telemetry data record stored within a telemetry database. Therefore, each video frame may be accessed by accessing the associated telemetry values through the database.

In the exemplary embodiment, control panel 102 includes an alphanumeric keypad 160 for entering text and numbers, including inquiries and commands. Control panel 102 further includes a plurality of preset switches 162 that may be programmed to execute macros that automatically control camera assembly 105 including, but not limited to, zoom features of lens assembly 126 and the panning and tilting mechanisms. A plurality of buttons 164 are used for predetermined control functions and/or user-defined functions, such as a camera selection in a multi-camera visual surveillance system. A display 166 is used to display a status of visual surveillance system 100 and/or parameters associated with camera 106.

Also, in the exemplary embodiment, visual surveillance system 100, and more specifically, control panel 102 includes at least one control panel processor 168 and control panel memory 170. Further, in the exemplary embodiment, control panel processor 168 and control panel memory 170 are located external to camera assembly 105, such as in control panel 102, or in a personal computer (PC) or other standalone computer system capable of performing the functions described herein. Processor 168 receives programmed instructions from sources that include, but are not limited to, software and firmware. Processor 168 also receives data from control panel memory 170 and performs various operations using the data and instructions. As used herein, references to “software” and “firmware” are interchangeable, and are to be understood to refer to and include any computer program stored in memory 170 for execution by processor 168.

Also, as used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or control system can also include memory, input channels, and/or output channels. Moreover, processor 168 as described herein processes information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, and/or a distributed control system.

Further, in the embodiments described herein, memory 170 may include, without limitation, a computer-readable medium, such as a random access memory (RAM), read-only memory (ROM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, alternatively, memory 170 may include programmable read-only memory (PROM), erasable programmable read-only memory (EPROM) and electrically erasable programmable read-only memory (EEPROM). RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, imaging system control commands. The execution of sequences of instructions is not limited to any specific combination of hardware circuitry and software instructions.

Moreover, in the embodiments described herein, input channels may include, without limitation, sensors and/or computer peripherals associated with an operator interface, such as a mouse and a keyboard. Further, in the exemplary embodiment, output channels may include, without limitation, control data channel 136. Memory 170 may also include storage locations for preset macro instructions that may be accessible using one of a plurality of preset switches 152.

In the exemplary embodiment, visual surveillance system 100 includes a camera control system 200 that includes control panel 102, display monitor 104, and a portion of visual surveillance camera assembly 105. Camera control system 200 is described in more detail below.

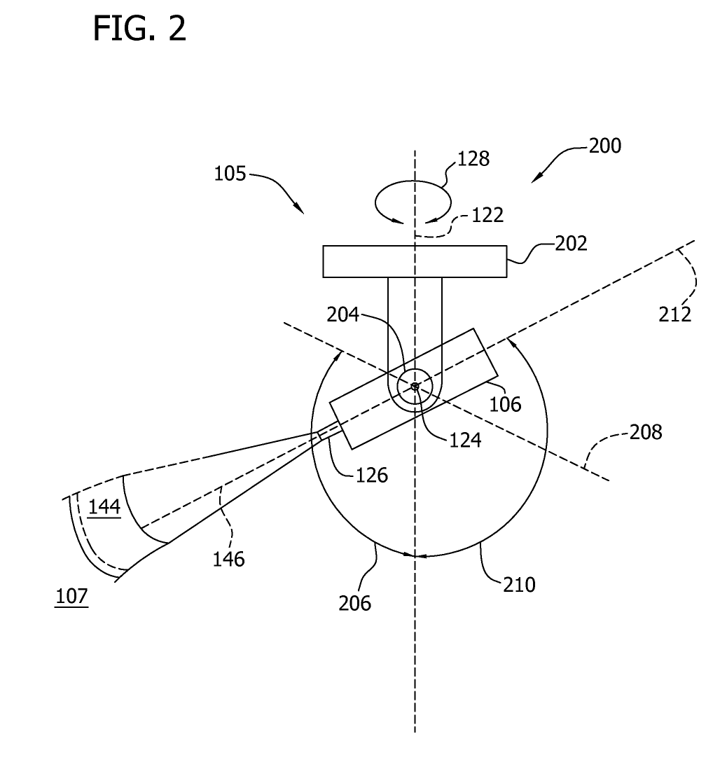

FIG. 2 is a schematic view of exemplary pan/tilt/zoom (PTZ) visual surveillance camera assembly 105 that may be used with visual surveillance system 100 (shown in FIG. 1) and camera control system 200 to visually surveil predetermined control area 107 as described above. As described above, visual surveillance camera assembly 105 includes PTZ-type visual surveillance camera 106. Assembly 105 also includes a pan mechanism 202 that is configured to rotate camera 106 about vertical pan axis 122 in a clockwise and a counter-clockwise pan direction as indicated by pan direction arrow 128. In the exemplary embodiment, pan mechanism 202 is configured to pan in any arcual portion of 360° about pan axis 122. Pan mechanism 202 is also configured to rotate camera 106 at a plurality of predetermined speeds, thereby at least partially defining a plurality of predetermined tour speeds.

Assembly 105 further includes a tilt mechanism 204 coupled to pan mechanism 202 and configured to rotate camera 106 about horizontal tilt axis 124 (illustrated normal to the page). In the exemplary embodiment, tilt mechanism 204 is configured to rotate camera 106 about tilt axis 124 through an arc greater than 90° that includes an angle 206 measured with respect to pan axis 122 and a first tilt position 208, and an angle 210 measured with respect to pan axis 122 and a second tilt position 212. Therefore, in the exemplary embodiment, the total tilt angle of camera 106 is greater than 180°. Tilt mechanism 204 is also configured to tilt camera 106 at a plurality of predetermined speeds, thereby at least partially defining the plurality of predetermined tour speeds.

In the exemplary embodiment, camera control system 200 includes control panel 102 (shown in FIG. 1), display monitor 104 (shown in FIG. 1), and portions of surveillance camera assembly 105, including, but not limited to, pan mechanism 202, tilt mechanism 204, and lens assembly 126. Control panel 102, or more specifically, processor 168 may generate demanded position signals that are transmitted to assembly 105 to position camera 106 at a predetermined position with respect to pan axis 122, tilt axis 124, and a zoom setting of lens assembly 126.

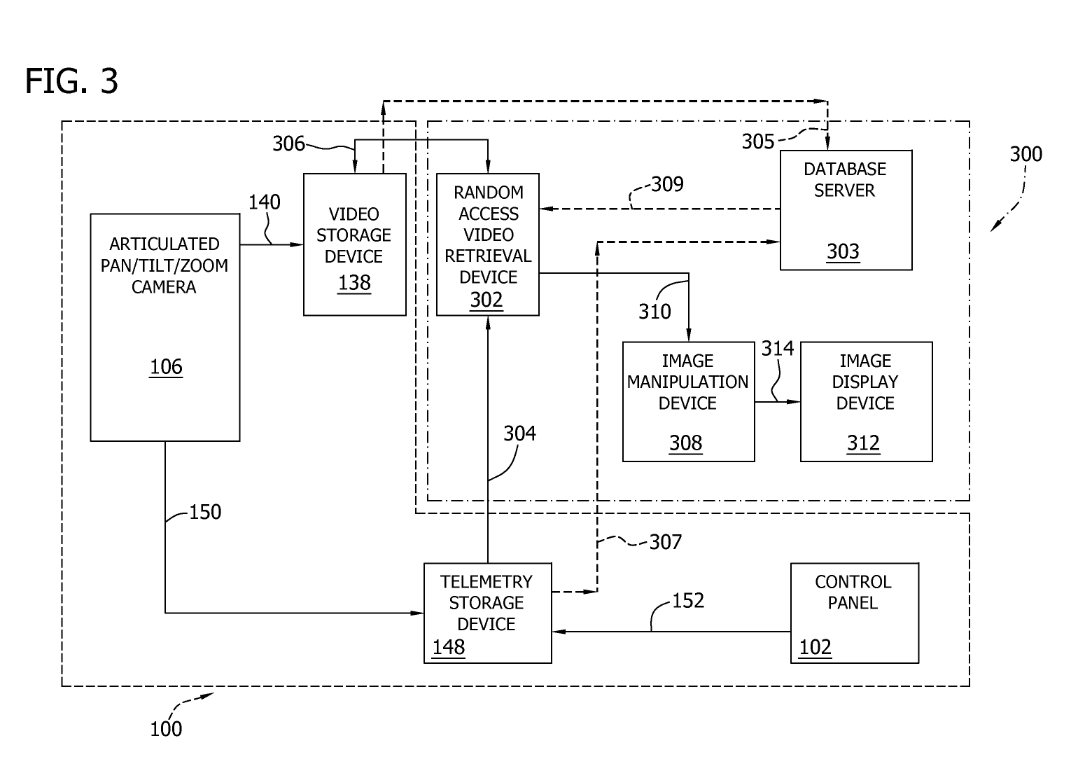

FIG. 3 is a schematic view of an exemplary video retrieval system 300 that may be used with visual surveillance system 100. In the exemplary embodiment, video retrieval system 300 includes a random access video retrieval device 302 coupled with telemetry storage device 148 and video storage device 138 via a query channel 304 and a video retrieval channel 306, respectively. Query channel 304 and video retrieval channel 306 are each configured to transmit electrical and/or digital signals substantially representative of an operator queries and video streams, respectively. As discussed above, telemetry storage device 148 is coupled with control panel 102 via control channel 152. Retrieval device 302 is configured to randomly access a video stream being transmitted through channel 306 independent of time, that is, any frame of the video stream can be accessed in a random, temporally non-linear order.

Also, in the exemplary embodiment, video retrieval system 300 includes at least one database server 303 coupled with video storage device 138, telemetry storage device 148, and random access video retrieval device 302 via data channels 305, 307, and 309, respectively. Data channels 305, 307, and 309 are configured to transmit electrical signals and/or digital signals substantially representative of the respective video streams and telemetry data. Server 303 is programmed to index each video image frame stored within video storage device 138 with an associated set of telemetry data stored within telemetry storage device 148. The database is programmed with at least one indexing scheme. The indexing scheme is programmed to map a video frame and its telemetry data to a substantially hemispherical virtual grid, wherein the grid represents substantially all possible positions that may be achieved by PTZ camera 106 within coordinate system 134 within the limitations of pan mechanism 202, tilt mechanism 204, and lens assembly 126 (all shown in FIG. 2). Alternatively, the indexing scheme is programmed to map a video frame and its telemetry data to a virtual grid of any geometrical shape that enables operation of system 300 as described herein. The indexing scheme disregards temporal data collected in conjunction with the video frames and telemetry data.

Further, in the exemplary embodiment, server 303 is programmed with any database application that enables operation of system 300 as described herein. Moreover, server 303 includes any number of processors (not shown) that enable operation of system 300 as described herein.

Also, in the exemplary embodiment, video retrieval system 300 includes an image manipulation device 308 coupled with retrieval device 302 via a video frames channel 310. Video frames channel 310 is configured to transmit signals substantially representative of the associated video frames. Device 308 is configured to scale, crop, and translate video frames. Further, in the exemplary embodiment, video retrieval system 300 includes at least one video display device 312 coupled to image manipulation device 308 via a channel 314. Channel 314 is configured to transmit signals substantially representative of the associated video frames. Video display device 312 is configured to render video frames in any manner that facilitates an operator's review.

Referring to FIGS. 1, 2, and 3, during operation, PTZ camera 106 is operated to perform a visual surveillance tour in either one of two modes, that is, in a manual tour mode with an operator driving PTZ camera 106 through a manual tour via control panel 102, or in an automated tour mode, wherein PTZ camera 106 is driven through at least one predetermined automated tour. During the tour, lens assembly 126 views a portion of control area 107 that is in field of view (FOV) 144 along viewing axis 146 of lens assembly 126 (all shown in FIG. 1). Also, during the tour, a plurality of time-sequenced video frames are transmitted from PTZ camera 106 to video storage device 138 via channel 140. The video frames are time-sequenced and are time-stamped appropriately. Video storage device 138 includes any amount of storage capacity that enables operation of system 300 as described herein.

Further, during the tour, PTZ camera 106 transmits metadata associated with each video image frame transmitted to and stored within video storage device 138 to the database programmed within database server 303 and thereby forms at least a partial telemetry record therein. In the exemplary embodiment, such metadata is telemetry data (described below). Alternatively, the metadata includes any characteristics of the associated video image frames that enables operation of system 300 as described herein.

Also, in operation, a set of telemetry signals is transmitted to telemetry storage device 148, and subsequently transmitted to database server 303. Such set of telemetry signals is substantially representative of coordinate values associated with predetermined coordinate system 134 (shown in FIG. 1). More specifically, the telemetry signals are substantially representative of a pan angle, a tilt angle, and FOV 144 as a function of a horizontal angle (not shown) with respect to vertical pan axis 122, and a vertical angle (not shown) with respect to horizontal tilt axis 124, wherein each angle is at least partially representative of a size value of an associated video frame in the respective dimension.

Further, in operation, each set of telemetry signals transmitted to telemetry storage device 148 is associated with, or indexed to a particular video frame transmitted to video storage device 138, such indexing being performed by the database programmed in server 303, thereby at least partially completing the associated telemetry database record formed therein.

Further, in operation, during archival video retrieval from video storage device 138, a user can select a frame for retrieval by leveraging the telemetry database programmed in server 303 in one of two retrieval modes, that is, a frame selection retrieval mode and a PTZ coordinate selection retrieval mode. In the frame selection mode, the user selects a desired frame from the archive based on a predetermined user criterion that is most likely an approximate position within control area 107. Once the image frame is selected, the user will use at least one of the tri-axial values (as defined by coordinate system 134) that most closely characterizes a center of this selected frame, and uses such coordinate value, or values, as a search value, or values. The user will then search the telemetry database for video frames that have the selected center coordinates as the recorded telemetry data.

Moreover, in operation, in the PTZ coordinate selection mode, the user selects any frame from the archive and then selects any position within this frame as the basis of the search values. To facilitate ease and speed of retrieval while in PTZ coordinate selection mode, a user points PTZ camera 106 into an area of interest, that is, the query area. Such query area is at least partially defined by the position of PTZ camera 106 as defined by the pan angle, the tilt angle, and FOV 144. Once the query area is defined, the user transmits a query command from control panel 102 to telemetry storage device 148 via channel 152. A search is conducted within the telemetry database in server 303 by device 148 for telemetry data sets that match the query area as defined by the coordinates of the query area. Telemetry data sets that have telemetry coordinates that match those of the query area will induce a query signal to be transmitted from telemetry storage device 148 to random access video retrieval device 302 via channel 304, such query signal including a command for device 302 to retrieve the video frames which have telemetry coordinates that are indexed to those of the query area. Therefore, retrieving the video frames based on the selected telemetry coordinates facilitates video frame extraction based on at least one PTZ coordinate regardless of the time-sequencing of the video frames, thereby enabling a reverse index mode.

Regardless of the selection mode used, all of the archived frames which fall within the area of interest are retrieved. Moreover, potentially relevant frames that at least partially contain information with respect to the query area can augment the search. For example, video frames that have at least some overlap with the query area, but which do not fully cover the query area, may be retrieved as well.

Also, in operation, regardless of which selection mode is used, each of the matching video frames are transmitted to image manipulation device 308 in conjunction with the desired query area parameters as well as the telemetry parameters of the retrieved video frames. The query telemetry parameters and the retrieved telemetry parameters may not necessarily match, however there will be at least some overlap. Image manipulation device 308 adjusts each of the retrieved video frames to match the query area telemetry parameters via methods that include, but are not limited to, scaling and/or cropping of the video frames. The resultant video frames substantially match the query area. Further, in operation, the retrieved video frames are then transmitted to image display device 312 via channel 314. The user then views the video in what would appear to be a time-linear stationary camera, but which is in fact, a collection of frames of video indexed to the queried area telemetry values.

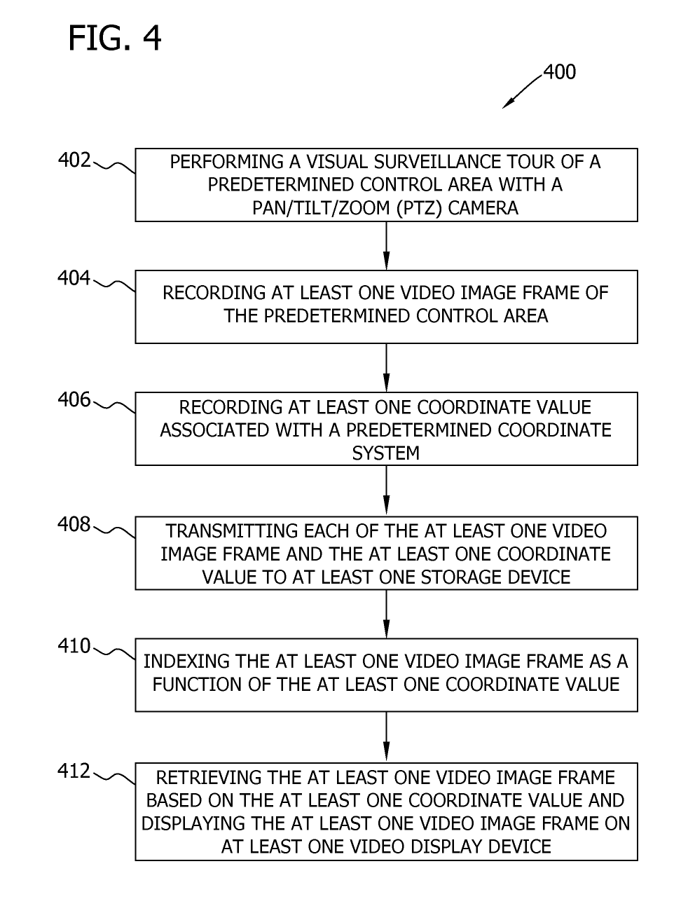

FIG. 4 is a flowchart of a method 400 for operating visual surveillance system 100, PTZ camera assembly 105, and video retrieval system 300 (shown in FIGS. 1-3, respectively). By performing method 400, each image from a video recorded during a visual surveillance tour is indexed to telemetry data recorded substantially simultaneously.

Referring to FIGS. 1, 2, 3, and 4, during operation of visual surveillance system 100, camera control system 200, and video retrieval system 300, a video stream is recorded and indexed to coordinate system 134. In the exemplary embodiment, method 400 includes performing 402 a visual surveillance tour of a predetermined control area 107 with pan/tilt/zoom (PTZ) camera 106. More specifically, during operation, system 200 drives camera 106 and controls the touring speed of camera 106 via pan mechanism 202 and tilt mechanism 204. Also, during operation, system 200 controls a zoom setting via lens assembly 126.

Also, during operation of systems 100, 200, and 300, method 400 includes recording 404 at least one video image frame of predetermined control area 107. Further, during operation of systems 100, 200, and 300, method 400 includes recording 406 at least one coordinate, or telemetry value associated with predetermined coordinate system 134. Moreover, during operation of systems 100, 200, and 300, method 400 includes transmitting 408 each of the at least one video image frame and the at least one telemetry value to at least one storage device 138 and 148. Specifically, camera 106 generates and transmits a video stream that is substantially representative of control area 107 to video storage device 138. In addition, in substantial synchronism, camera 106 generates and transmits a video telemetry stream that is substantially representative of position feedback associated with current PTZ position for each of a plurality of video image frames produced to telemetry storage device 148.

Further, during operation of systems 100, 200, and 300, method 400 includes indexing 410 the at least one video image frame as a function of the at least one telemetry value. Specifically, the telemetry values are transmitted from telemetry storage device 148 to database server 303. The telemetry values are substantially representative of coordinate values associated with predetermined coordinate system 134. More specifically, the telemetry signals are substantially representative of a pan angle, a tilt angle, and FOV 144 as a function of a horizontal angle (not shown) with respect to vertical pan axis 122, and a vertical angle (not shown) with respect to horizontal tilt axis 124, wherein each angle is at least partially representative of a size value of an associated video frame in the respective dimension. Each of telemetry values transmitted to telemetry storage device 148 is associated with, or indexed to a particular video frame transmitted to video storage device 138, such indexing being performed by the database programmed in server 303. Subsequently, during video retrieval from video storage device 138, a user can select a frame for retrieval by leveraging the telemetry database programmed in server 303.

Moreover, during operation of systems 100, 200, and 300, method 400 includes retrieving 412 the at least one video image frame based on the at least one coordinate value and displaying the at least one video image frame on video display device 312. Subsequently, a user may view the video in what would appear to be a time-linear stationary camera, but which is in fact, a collection of frames of video indexed to the queried area telemetry values.

The above-described embodiments provide a video system that is based on a video retrieval system that indexes each recorded video image frame to a distinct set of coordinates. The retrieval method as described herein facilitates access to PTZ camera-based video data by indexing each video image frame to a specific set of telemetry coordinates that include pan angle, tilt angle, and zoom setting, that collectively define a field of view (FOV). Indexing the video image frames with the telemetry coordinates facilitates review of recorded video wherein only video associated with a particular area of interest in a control area is examined. Excluding video of no or little interest in the video review activities significantly reduces a period of time used for such review.

Therefore, as described herein, retrieving recorded video as a function of a particular set of telemetry coordinates that were recorded substantially simultaneously with the recorded video image frames facilitates investigation of particular objects, such as doors, windows, automobiles, people, and loose articles. The ability to more quickly retrieve video of interest allows for use of articulated and dynamic PTZ cameras to tour a control area, thereby increasing a size of the monitored control area without extending and complicating subsequent reviews.

Another advantage to retrieving recorded video as a function of a particular set of telemetry coordinates as described herein is that the video image frames are scaled and cropped as necessary to generate a video stream that is apparently substantially stabilized. Therefore, playback of video image frames indexed to a consistent set of telemetry coordinates all recorded from moving PTZ camera provides a user with an illusion that the camera is substantially steady throughout the recording period with an apparently substantially consistent scaling of the images formed on the display.

A technical effect of the systems and method described herein includes at least one of: (a) performing a visual surveillance tour of a predetermined control area with a pan/tilt/zoom (PTZ) camera; (b) recording at least one video image frame of the predetermined control area; (c) recording at least one coordinate value associated with a predetermined coordinate system; (d) transmitting each of the at least one video image frame and the at least one coordinate value to at least one storage device; (e) indexing the at least one video image frame as a function of the at least one coordinate value; and (f) retrieving the at least one video image frame based on the at least one coordinate value and displaying the at least one video image frame on at least one video display device.

Exemplary embodiments of video system and method for operating the same are described above in detail. The method and systems are not limited to the specific embodiments described herein, but rather, components of systems and/or steps of the methods may be utilized independently and separately from other components and/or steps described herein. For example, the method may also be used in combination with other video systems and methods, and are not limited to practice with only the video system and method as described herein. Rather, the exemplary embodiment can be implemented and utilized in connection with many other video system applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for operating a video system comprising:
performing a visual surveillance tour of a predetermined control area with a pan/tilt/zoom (PTZ) camera;
recording at least one video image frame of the predetermined control area;
recording at least one coordinate value associated with a predetermined coordinate system;
transmitting each of the at least one video image frame and the at least one coordinate value to at least one storage device;
indexing the at least one video image frame as a function of the at least one coordinate value; and
retrieving the at least one video image frame based on the at least one coordinate value and displaying the at least one video image frame on at least one video display device.

2. A method in accordance with claim 1, wherein retrieving the at least one video image frame based on the at least one coordinate value comprises:
selecting at least one first video image frame from the at least one storage device;
determining at least one coordinate value that substantially represents a position within the at least one first video image frame; and
searching within the at least one storage device for at least one second video image frame having a position that is at least partially defined by the at least one coordinate value.

3. A method in accordance with claim 2, wherein determining at least one coordinate value that substantially represents a position within the at least one first video image frame comprises determining at least one coordinate value that substantially represents a center portion of the at least one first video image frame.

4. A method in accordance with claim 2, wherein determining at least one coordinate value that substantially represents a position within the at least one first video image frame comprises:
pointing the PTZ camera into an area of interest within the control area; and
determining at least one coordinate value that substantially defines at least a portion of the area of interest.

5. A method in accordance with claim 4, wherein determining at least one coordinate value that substantially defines at least a portion of the area of interest comprises transmitting at least one coordinate value signal from the at least one PTZ camera to the at least one storage device.

6. A method in accordance with claim 2 further comprising retrieving at least one third video image frame that includes at least one coordinate positioned within the area of interest.

7. A method in accordance with claim 1, wherein retrieving the at least one video image frame based on the at least one coordinate value comprises manipulating the at least one video image frame.

8. A method in accordance with claim 7, wherein manipulating the at least one video image frame comprises at least one of scaling and cropping of the at least one video image frame.

9. A method in accordance with claim 8, wherein at least one of scaling and cropping of the at least one video image frame comprises generating a video stream having a substantially continuous display scaling that is substantially stabilized.

10. A method in accordance with claim 1, wherein recording at least one coordinate value associated with a predetermined coordinate system comprises recording at least one of a PTZ camera pan position value, a PTZ camera tilt position value, and a field of view value.

11. A method in accordance with claim 1, wherein performing a visual surveillance tour comprises performing the visual surveillance tour in one of a manual tour mode and an automatic tour mode.

12. A method in accordance with claim 1, wherein indexing the at least one video image frame as a function of the at least one coordinate value comprises mapping a video stream on a per frame basis into an indexed substantially hemispherical database based on at least one PTZ coordinate.

13. A method in accordance with claim 1, wherein retrieving the at least one video image frame based on the at least one coordinate value comprises facilitating video frame extraction based on at least one PTZ coordinate regardless of a time-sequencing of the at least one video frame.

14. A video system comprising:
at least one video retrieval device; and
at least one processor coupled with said at least one video retrieval device, said at least one processor programmed to index at least one video image frame as a function of at least one coordinate value associated with a predetermined coordinate system.

15. A video system in accordance with claim 14, wherein said at least one processor is coupled with at least one storage device.

16. A video system in accordance with claim 15, wherein said at least one processor is programmed to command said at least one video retrieval device to retrieve the at least one video image frame from said at least one storage device based on the at least one coordinate value.

17. A video system in accordance with claim 16, wherein said at least one processor is further programmed to:
command said at least one video retrieval device to select at least one first video image frame from said at least one storage device;
determine at least one coordinate value that substantially represents a position within the at least one first video image frame; and
command said at least one video retrieval device to search within said at least one storage device for at least one second video image frame having a position that is at least partially defined by the at least one coordinate value.

18. A video system in accordance with claim 14, wherein said at least one storage device comprises at least one of a video storage device and a telemetry storage device.

19. A video system in accordance with claim 14 further comprising at least one of an image manipulation device and an image display device, wherein said at least one image manipulation device is programmed to at least one of scale and crop the at least one video image frame.

20. A video system in accordance with claim 14, wherein the at least one coordinate value associated with the predetermined coordinate system comprises at least one of a pan/tilt/zoom (PTZ) camera pan position value, a PTZ camera tilt position value, and a field of view value.
